(19) United States
(12) Patent Application Publication
(10) Pub. No.: US 2025/0313071 A1
(43) Pub. Date: Oct. 9, 2025

(54) Integrated Camera-Compatible Vehicle Cover with Enhanced Security Features

(71) Applicant: Ricardo Isaac Rico-Madrazo, Tarpon Springs, FL (US)

(72) Inventor: Ricardo Isaac Rico-Madrazo, Tarpon Springs, FL (US)

(21) Appl. No.: 18/629,979

(22) Filed: Apr. 9, 2024

(51) Int. Cl. B60J 11/04

(52) U.S. Cl. CPC B60J 11/04

(57) ABSTRACT

The present disclosure pertains to a vehicle cover apparatus designed to accommodate vehicles equipped with integrated sensor arrays for enhanced security and surveillance. The apparatus consists of a flexible cover body featuring a concave inner surface that forms a cavity tailored to envelop a variety of vehicle shapes and sizes. Central to the invention are strategically placed openings in the cover body, including at least one top opening and at least two side openings on opposing sides, each positioned to provide a field of view for corresponding sensors within the vehicle's sensor array. To secure the cover body around the vehicle and maintain the precise alignment of these openings with the vehicle's sensors, the invention incorporates means for ensuring a firm fit, such as elastic members, tensioning straps, or adjustable fasteners, alongside means for adjusting the cover body's position relative to the vehicle.

### FIELD OF INVENTION

The present invention relates generally to the field of vehicle accessories, specifically to a vehicle cover designed to protect vehicles from environmental elements while incorporating features that allow for the use of integrated vehicle cameras, thereby enhancing security and surveillance capabilities without compromising protection.

### BACKGROUND

In recent years, the automotive industry has witnessed significant advancements in vehicle security systems, particularly with the integration of sophisticated camera technologies designed to offer enhanced surveillance and safety for parked and operational vehicles. These cameras, strategically embedded within the vehicle's structure, serve a crucial role in monitoring surroundings, detecting potential threats, and providing evidence in the event of theft or vandalism. However, the efficacy of these security features is heavily compromised when vehicles are covered for protection against environmental elements. Traditional vehicle covers, while serving the essential function of shielding vehicles from the detrimental effects of weather, including sun exposure, rain, hail, snow, and sandstorms, fail to accommodate the operational needs of integrated camera systems. These covers, typically fashioned from flexible fabrics, are designed without consideration for the technological advancements in vehicle security, resulting in a complete negation of surveillance capabilities when vehicles are ostensibly protected by these covers.

The current landscape of vehicle covers demonstrates a significant oversight in design, where the primary focus has been on material durability, flexibility, and environmental protection, with little to no attention paid to the evolving functionalities of modern vehicles. The conventional approach to vehicle cover design does not offer solutions for maintaining the functionality of integrated cameras, thereby presenting a paradox where the vehicle, though protected from physical and environmental damage, is left vulnerable to security breaches. This oversight is particularly concerning in scenarios where vehicles are stored or parked for extended periods, especially in outdoor or unsecured locations, where the risk of theft or damage is elevated.

Moreover, the absence of a mechanism to ensure the proper alignment of cover openings with vehicle cameras further exacerbates the problem, as it undermines the potential for any makeshift solutions to maintain camera functionality. The lack of dedicated features for camera integration in vehicle covers also leads to increased setup time and inconvenience for vehicle owners, who might seek to manually create openings or adjustments, thereby risking damage to both the cover and the vehicle's exterior. This situation underscores a clear gap in the market for a vehicle cover that not only provides comprehensive protection from environmental factors but also seamlessly integrates with the vehicle's security systems, ensuring uninterrupted surveillance and safety.

Thus, the limitations and drawbacks of existing vehicle covers, including their failure to accommodate modern vehicle security technologies and the absence of features for the easy integration of camera functionalities, have led to the recognition of an urgent need for innovation in this domain. The development of a solution that addresses these challenges is not only necessary for enhancing vehicle security while covered but also represents a significant advancement in the field of vehicle protection accessories, reflecting the evolving needs of modern vehicles and their owners.

It is within this context that the present invention is provided.

### SUMMARY

The present invention introduces a versatile and innovative vehicle cover apparatus designed to effectively overcome the limitations associated with traditional vehicle covers, particularly in the context of modern vehicles equipped with integrated sensor arrays. This invention addresses these limitations by incorporating strategically positioned openings within the cover body, aligned precisely to ensure unobstructed visibility for both top and side vehicle sensors. Through the implementation of adjustable securing mechanisms and materials specifically chosen for their protective and flexible properties, the apparatus not only maintains the protective functions of conventional covers but also enhances the vehicle's security capabilities without sacrificing coverage.

The invention thus relates to a vehicle cover apparatus designed to accommodate vehicles equipped with sensor arrays, including at least one top sensor and at least two side sensors. The apparatus comprises a flexible cover body with a concave inner surface forming a cavity for the vehicle, at least one top opening, and at least two side openings on opposing sides of the cover body. These openings are positioned to provide fields of view for the sensors when the cover is deployed. The invention also features means for ensuring a firm fit around the vehicle and for adjusting the cover body's position to ensure precise alignment of the openings with the vehicle's sensors.

In some embodiments, the invention includes elastic members integrated into the cover body's hems or internal passages. These elastic members can stretch to conform to the vehicle's contours and retract to securely fit around the vehicle, facilitating a snug engagement with various vehicle shapes and sizes.

In other embodiments, tensioning straps or adjustable fasteners are employed as the means for ensuring a firm fit. This configuration allows for the secure positioning of the cover body, maintaining the alignment of the openings with the vehicle's sensor array, and accommodating vehicles of different dimensions.

Further embodiments include a plurality of adjustable straps for fine-tuning the cover body's position relative to the vehicle. These straps, equipped with fastening mechanisms, enable precise alignment of the sensor openings with the vehicle's sensors, ensuring optimal functionality of the sensors while the cover is in use.

Some embodiments offer various mechanisms for adjusting the position of the cover body, including adjustable straps, sliders, and tabs adjacent to the openings. These features allow for manual alignment of the openings with the vehicle's sensor array, providing versatility in fitting the cover to different vehicle models.

Additionally, the invention may incorporate a securing mechanism to hold the cover in place over the vehicle. Options for this mechanism include magnets, suction cups, adhesive devices, and hook-and-loop fasteners, offering flexibility in securing the cover under various conditions.

In some embodiments, the openings are defined by reinforced edges. This enhancement maintains the integrity of the openings during use, ensuring durability and long-term performance of the cover.

The invention also contemplates the inclusion of transparent or translucent covers for the sensor openings. These attachable covers protect the sensors from environmental elements while allowing visibility and sensor functionality, providing an additional layer of protection.

Another embodiment introduces mesh material covers for one or more of the openings. The mesh allows air and moisture to pass through while still providing a field of view for the sensors, optimizing the cover's breathability and sensor functionality.

In some embodiments, the cover apparatus comprises one or more back sensor openings.

Finally, the flexible cover body is fabricated from materials selected for their environmental protection qualities, such as waterproof, breathable, and UV-resistant fabrics. This selection ensures that the vehicle is protected from a variety of environmental elements while under the cover.

### BRIEF DESCRIPTION OF THE DRAWINGS

Various embodiments of the invention are disclosed in the following detailed description and accompanying drawings.

FIG. 1 illustrates an example of the vehicle cover installed on a smart car equipped with a sensor array.

FIG. 2 illustrates an example of the vehicle cover adapted to a different vehicle model, featuring additional straps for securing the cover.

FIG. 3A shows an example configuration of the vehicle cover with a smaller opening adjacent to the main side opening for manual adjustment.

FIG. 3B depicts an example where a tab is used at the edge of the main side opening for manual alignment adjustments.

FIG. 4A illustrates an example where the top and side openings of the vehicle cover are covered with a transparent mesh material.

FIG. 4B shows an example where the openings are covered with a transparent layer of glass or plastic, providing visibility while protecting against elements.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “flexible cover body” as used herein refers to a pliable structure designed to envelop the exterior of a vehicle. This structure is made from materials that allow it to conform to the contours of various vehicle shapes and sizes, including but not limited to cars, trucks, SUVs, and recreational vehicles. Suitable materials for the flexible cover body include, without limitation, polyester, polyethylene, nylon, and other synthetic fabrics known for their durability, water resistance, and ability to protect against environmental elements such as UV rays, rain, and snow. The flexibility of the cover body also allows for easy installation and removal by users.

The “sensor array” mentioned herein encompasses any configuration of electronic devices equipped on a vehicle for the purposes of security, navigation, and external environment monitoring. This includes, but is not limited to, cameras, radar devices, ultrasonic sensors, and LIDAR units. The sensor array can be located in various positions on the vehicle, including on the front, rear, sides, and top of the vehicle, to provide comprehensive coverage and functionality. The invention's design accommodates these sensor locations through corresponding openings in the cover body, ensuring that the sensor array remains operational even when the vehicle is covered.

The “openings” in the cover body are strategically positioned cuts or apertures designed to align with the sensors of a vehicle's sensor array. These openings allow the sensors to function without obstruction, providing visibility and operational capacity for security and surveillance purposes. The edges of these openings may be reinforced or otherwise treated to prevent fraying or damage, and they can be equipped with additional features such as transparent or translucent covers made from materials like clear plastic or glass to protect the sensors from environmental debris while maintaining their functionality.

The term “means for ensuring a firm fit” refers to any component or mechanism integrated into or used in conjunction with the cover body to secure it around the vehicle, preventing it from being dislodged by wind, movement, or tampering. Examples of such means include, but are not limited to, elastic hems, drawstrings, tensioning straps, adjustable fasteners, and hook-and-loop fasteners. These elements are designed to be adjustable to accommodate different vehicle sizes and shapes, ensuring a snug fit that maintains the proper positioning of the sensor openings relative to the vehicle's sensors.

The term “means for adjusting the position” encompasses mechanisms or features that allow the user to adjust the placement of the cover body on the vehicle, ensuring that the openings for the sensors are correctly aligned with the sensors themselves. Such mechanisms may include adjustable straps with buckles, sliding adjusters, or other manual or automated adjustment devices. These adjustments ensure that the cover can be adapted to fit a wide range of vehicle models and sensor configurations, providing flexibility and ease of use for the vehicle owner.

### DESCRIPTION OF DRAWINGS

The present invention relates to a vehicle cover apparatus designed to protect vehicles from environmental elements while ensuring the functionality of the vehicle's integrated sensor array. The apparatus consists of a flexible cover body that is shaped to form a cavity capable of accommodating a variety of vehicle shapes and sizes. A key feature of the invention is the inclusion of strategically placed openings within the cover body. These openings are specifically designed to align with the sensors of the vehicle's sensor array, including at least one top sensor and at least two side sensors, ensuring that these sensors remain operational even when the vehicle is covered.

To address the challenge of maintaining a secure and precise fit over vehicles of differing dimensions, the invention incorporates means for ensuring a firm fit of the cover body around the vehicle. These means may include, but are not limited to, elastic members, tensioning straps, or adjustable fasteners, which are capable of conforming to the vehicle's contours and securing the cover in place. Additionally, the invention features means for adjusting the position of the cover body relative to the vehicle. This allows for the fine-tuning of the cover's placement to ensure that the openings are correctly aligned with the vehicle's sensors, thereby optimizing the functionality of the sensor array under the cover.

The design of the invention allows for its application across a broad spectrum of vehicle types, including cars, trucks, SUVs, and recreational vehicles, irrespective of their specific sensor configurations.

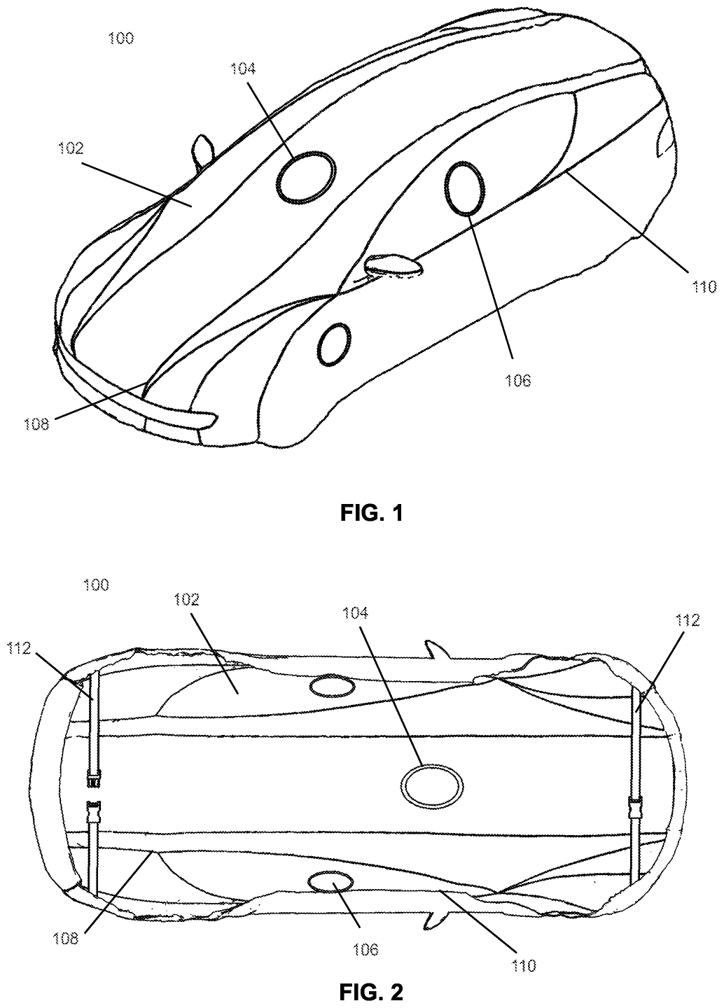

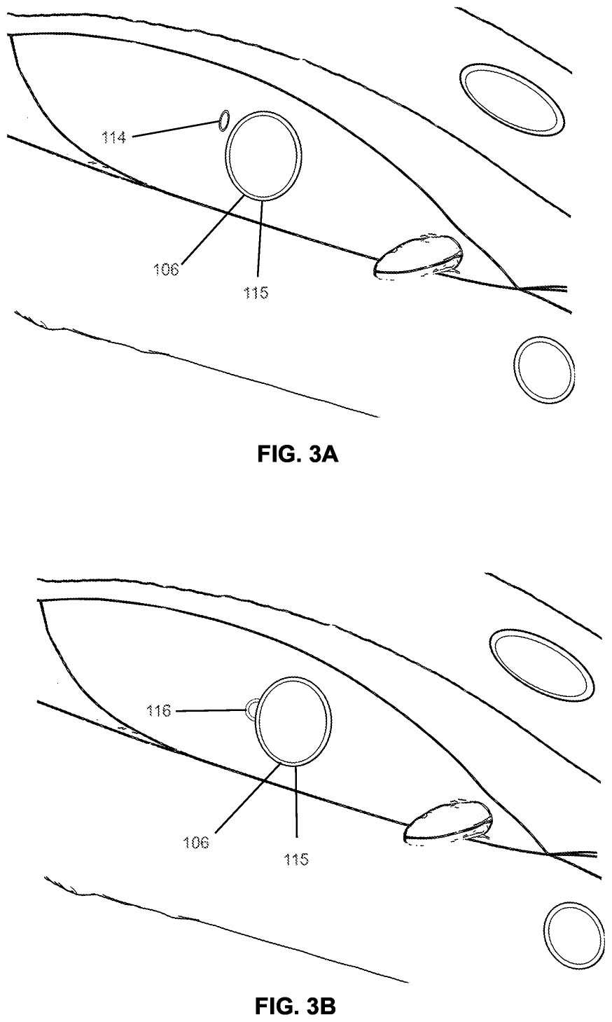

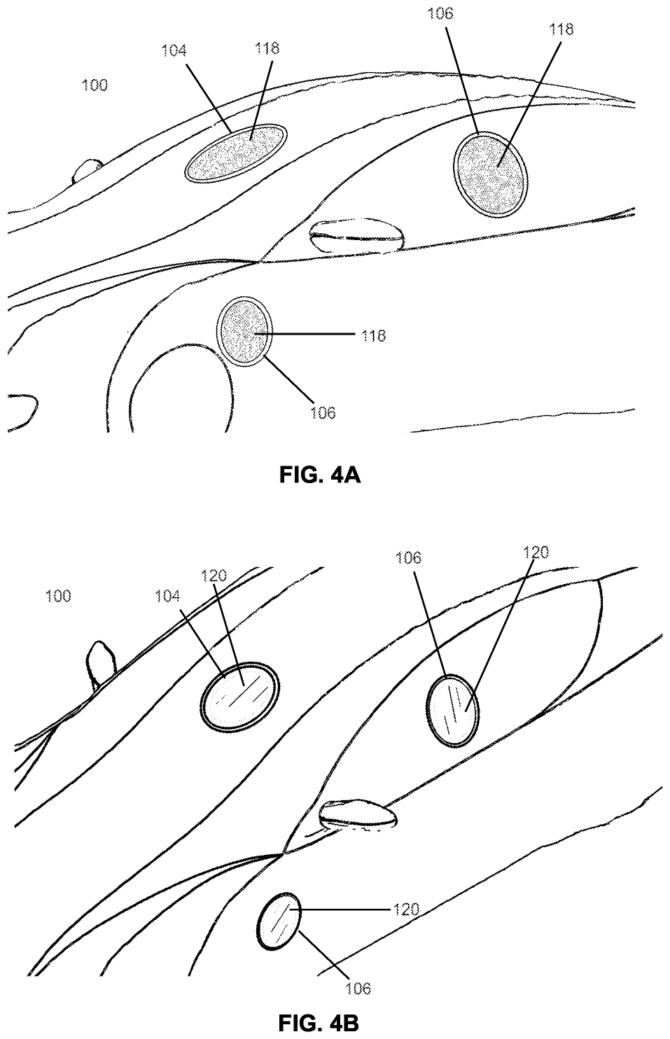

FIG. 1 presents an isometric perspective view of the vehicle cover apparatus 100 as installed on a smart car equipped with a sensor array. The vehicle cover body 102 is depicted as enveloping the entirety of the vehicle, with exceptions for a top opening 104 and two side openings 106 visible in this view. It should be noted that an additional pair of side openings, symmetrically arranged to the visible ones, are present on the opposite side of the vehicle but are not visible in this figure. The cover body 102 is designed with contours 108 that follow the shape of the vehicle, ensuring a snug fit that is tailored to the specific model. An elastic band 110 encircles the base of the vehicle, securing the cover body 102 in place and providing a tight fit around the vehicle. Each of the openings, including the top opening 104 and the side openings 106, is strategically aligned with the vehicle's sensor array to ensure optimal functionality of the sensors while the cover is in use.

FIG. 2 illustrates an isometric top-down view of the vehicle cover apparatus 100 installed on a different model of vehicle. In this embodiment, there is one side opening 106 on each side of the vehicle, in addition to the top opening 104. This version of the vehicle cover also incorporates additional straps 112 that are designed for tightening the cover around the vehicle. These straps 112 are secured by buckles, and facilitate further securing of the cover and allow for precise adjustment of the openings over the vehicle's sensors, ensuring that the sensors remain unobstructed and fully functional.

FIG. 3A and FIG. 3B depict two example configurations for manually adjusting the position of the vehicle cover 100 to achieve optimal alignment of the openings with the vehicle's sensors. In FIG. 3A, a smaller opening 114 is introduced adjacent to a main side opening 106, positioned over the vehicle's window. This smaller opening 114 provides a means for the user to manually adjust the cover's position by tugging on it, allowing for fine adjustments to ensure the main opening 106 aligns accurately with the sensor. Similarly, in FIG. 3B, a tab 116 is positioned at the edge of the main side opening 106, also over the vehicle window. The tab 116 serves a comparable purpose, offering the user a simple method to adjust the cover by pulling on the tab, thereby ensuring the precise positioning of the cover relative to the vehicle's sensors. The openings 106 in this embodiment are also shown with reinforcing material 115 around the edges.

FIG. 4A and FIG. 4B illustrate two variations of the vehicle cover apparatus 100, focusing on adaptations designed to maintain the protective capabilities of the cover while ensuring visibility for the vehicle's sensor array. In both figures, the top opening 104 and the side openings 106 are modified to include coverings that are either transparent or partially transparent. This modification allows the cover to continue offering comprehensive protection from environmental elements without compromising the functionality of the vehicle's sensors.

In FIG. 4A, the openings—specifically, the top opening 104 and side openings 106—are covered with a transparent mesh 118. This mesh material is selected for its ability to provide a clear field of view for the sensors, thereby enabling their operational capabilities, while also allowing air and moisture to pass through. The transparency of the mesh 118 ensures that the sensor array can function as intended, monitoring the surroundings of the vehicle without obstruction, even when the vehicle is fully covered.

Conversely, FIG. 4B depicts the openings being covered with a transparent layer made of glass or plastic 120. This layer serves a similar purpose to the mesh in FIG. 4A but offers a different balance of properties, potentially providing greater protection against direct impacts, heavier rain, and other environmental factors. The choice between glass and plastic as materials for the transparent layer 120 would be determined based on considerations such as durability, clarity, weight, and impact resistance. Both the glass and plastic options ensure that the sensor array retains a clear field of view through the cover, thus maintaining the vehicle's security and surveillance capabilities even when it is covered.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the vehicle cover of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A vehicle cover apparatus, comprising:
a flexible cover body having a concave inner surface that forms a cavity, wherein the cavity is shaped to receive a vehicle, the vehicle being characterized as having a sensor array that includes at least one top sensor and at least two side sensors located on opposing sides of the vehicle;
at least one top opening formed in the cover body, the at least one top opening being positioned to provide a field of view to the at least one top sensor of the vehicle sensor array when the cover is deployed over the vehicle;
at least two side openings disposed on opposing sides of the flexible cover body, each of the at least two side openings being configured to provide a field of view to at least one of the at least two corresponding side sensors of the vehicle sensor array;
means for ensuring a firm fit of the cover body around the vehicle; and
means for adjusting the position of the cover body relative to the vehicle to ensure that the at least one top opening and the at least two side openings are precisely aligned with the at least one top sensor and the at least two side sensors of the vehicle sensor array, respectively.

2. The vehicle cover apparatus of claim 1, wherein the means for ensuring a firm fit around the vehicle includes elastic members that are integrated into one or more hems or internal passages on the inner surface of the cover body, the elastic members being stretchable to conform to the contours of the vehicle and retractable to snugly secure the cover body around the vehicle.

3. The vehicle cover apparatus of claim 1, wherein the means for ensuring a firm fit comprises tensioning straps or adjustable fasteners, which are configured to secure the cover body in a manner that maintains the relative positioning of the at least one top opening and the at least two side openings with respect to the vehicle's sensor array.

4. The vehicle cover apparatus of claim 1, wherein the means for adjusting the position of the cover body comprises a plurality of adjustable straps, each strap having one end attached to the cover body and an opposite end equipped with a fastening mechanism for securing the strap to a portion of the vehicle, thereby allowing for fine-tuning of the cover body's position relative to the vehicle.

5. The vehicle cover apparatus of claim 1, wherein the means for adjusting the position is selected from a group consisting of: adjustable straps, sliders, tabs adjacent to the one or more openings, and smaller openings adjacent to the one or more openings for manual alignment of the openings with the vehicle sensor array.

6. The vehicle cover apparatus of claim 1, further comprising a securing mechanism for holding the cover in place over the vehicle, the securing mechanism selected from a group consisting of: magnets, suction cups, adhesive devices, and hook-and-loop fasteners.

7. The vehicle cover apparatus of claim 1, wherein the at least one top opening and the at least two side openings are further defined by reinforced edges to maintain the integrity of the openings during use.

8. The vehicle cover apparatus of claim 1, further comprising transparent or translucent covers for the at least one top opening and the at least two side openings, said covers being attachable to the openings to protect the sensors from environmental elements while allowing for visibility and functionality of the sensors.

9. The vehicle cover apparatus of claim 1, further including at least one mesh material cover for at least one of the openings, wherein the mesh material allows for air and moisture to pass through while still providing a field of view for the sensors.

10. The vehicle cover apparatus of claim 1, wherein the flexible cover body is fabricated from a material selected from the group consisting of: waterproof fabric, breathable fabric, UV-resistant fabric, and combinations thereof, to provide environmental protection to the vehicle.

11. The vehicle cover apparatus of claim 1, further comprising one or more back sensor openings.
